(19) United States
(12) Patent Application Publication
(10) Pub. No.: US 2003/0084365 A1
(43) Pub. Date: May 1, 2003

(54) Signal transmitting/receiving system reducing timing skew between clock signal and data

(75) Inventor: Takashi Kubo, Hyogo (JP)

Correspondence Address: McDERMOTT, WILL & EMERY, 600 13th Street, N.W., Washington, DC, 20005-3096, US

(73) Assignee: Mitsubishi Denki Kabushiki Kaisha

(21) Appl. No.: 10/134,574

(22) Filed: Apr. 30, 2002

(30) Foreign Application Priority Data
Oct. 30, 2001 (JP) 2001-332059(P)

(51) Int. Cl. G06F 1/04

(52) U.S. Cl. 713/500; 713/400

(57) ABSTRACT

The memory system includes a control block and a plurality of memories. The control block includes a transmitting section for transmitting a data read instruction to the memories, and a receiving section for receiving data stored in the memories. The memory system further includes an annular signal line starting from the transmitting section of the control block and terminating at the receiving section thereof, and a signal line connecting the annular signal line to the memories. The annular signal line transfers a signal in only one direction. The control block, memories and annular signal line are arranged at a surface formed in a three-dimensional space.

### BACKGROUND OF THE INVENTION

1. Field of the Invention

The present invention generally relates to transmission/reception of a signal between a plurality of functional blocks in a computer system. More particularly, the present invention relates to a signal transmitting/receiving system in a functional block (such as a memory) operating in synchronization with a clock signal.

2. Description of the Background Art

The existing memory system operating in synchronization with a clock signal has a timing skew between the clock signal and data. The timing skew will now be described with reference to FIG. 1. FIG. 1 shows the structure of a common memory bus system. The memory bus system includes a clock generator 100 for generating a clock at a predetermined frequency, a controller 110 for controlling a first memory 112, a second memory 114, a third memory 116 and a fourth memory 118 to write and read data to and from the memory, a clock signal line 120, a command signal line 122, and a data signal line 124.

According to this memory system, a read instruction from the controller 110 is fetched in the memory in synchronization with a clock generated by the clock generator 100. After read operation within the memory, the memory transfers the data toward the controller. The time required for the data from the memory to reach the controller 110 varies between the first memory 112 located near the controller 110 and the fourth memory 118 located far therefrom. In contrast, a write instruction from the controller 110 is fetched in the memory in synchronization with a clock generated by the clock generator 100. The controller 110 transfers the data toward the memory after a predetermined clock cycle from the write instruction. The time required for the data from the controller 110 to reach the memory varies between the first memory 112 located near the controller 110 and the fourth memory 118 located far therefrom.

FIG. 2 is a timing chart illustrating this state. As shown in FIG. 2, in both write and read instructions, the timing skew between the clock signal and the data is increased in proportion to the distance from the controller 110 and the memory. The timing skew may exceed one clock due to an increased circuit scale and a clock at an increased frequency. Such an increased timing skew makes it very difficult to implement synchronized operation, or otherwise requires extremely complicated circuitry.

In order to solve such a timing-skew problem, a memory system as shown in FIG. 3 transfers a command and write data in synchronization with an outgoing clock and transfers read data in synchronization with a returning clock. This memory system includes the following signal lines connecting a controller 130 and the memories with each other: a command signal line 140; a data signal line 142; a returning clock signal line 144; and an outgoing clock signal line 146.

This memory system is capable of suppressing generation of the timing skew, but has the following problem: as shown in FIG. 4, the time required for the fourth memory 118 located far from the controller 130 to output the data after receiving a read instruction, that is, the latency of the read operation, is shorter than that of the first memory 112 located near the controller 130.

Japanese Patent Laying-Open No. 10-143424 discloses a memory system that solves the above problems regarding the timing skew and latency. FIG. 5 shows an application of the memory system disclosed in this publication. In this memory system, a controller 160 and memories 112 to 118 are connected to each other through a clock signal line 170, a data signal line 172 and a command signal line 174. These signal lines connect a receiving section 162 and a transmitting section 164 of the controller 160 in an annular manner, and transmit a signal in the same direction. In this case, as shown in FIG. 6, the signal lines are formed along a flat surface. Therefore, two annular wirings connecting the receiving section 162 and the transmitting section 164 (one for outgoing and the other for returning) are required for each type of signal. Moreover, as shown in FIGS. 7 to 9, the plurality of signal lines must have the same wiring length between the receiving section 162 and the transmitting section 164.

FIG. 10 is a timing chart of the memory system thus structured. As shown in FIG. 10, this memory system is improved in terms of the timing skew and the difference in latency which are caused by the difference in distance between the controller 160 and the memories 112 to 118.

However, in the memory system of FIG. 5, i.e., the application of the technology disclosed in the above publication, the command and data are not accurately aligned with a clock, as shown in FIG. 11. This results from the difficulty in arranging signal lines having exactly the same length between pins as shown in FIGS. 7 to 9.

For example, it is difficult to slacken off the inner annular signal line as shown in FIG. 7 in order to eliminate the difference in length between the outer and inner annular signal lines. It is also difficult to cause the inner and outer annular signal lines to cross each other by using a via hole in a printed circuit board while eliminating the difference in length therebetween, as shown in FIG. 8. Moreover, it is difficult to form the inner and outer annular signal lines with the same length in view of the arrangement of input/output pins of a chip 166 in a package 168, as shown in FIG. 9. It may be impossible to mount the annular signal lines so as to eliminate the difference in length between the inner and outer annular signal lines.

### SUMMARY OF THE INVENTION

It is an object of the present invention to provide a transmitting/receiving system for transferring a signal between a plurality of functional blocks, which is capable of suppressing generation of a timing skew.

It is another object of the present invention to provide a transmitting/receiving system for transferring a signal between a plurality of functional blocks, which is capable of suppressing the difference in latency.

It is still another object of the present invention to provide a transmitting/receiving system for transferring a signal between a plurality of functional blocks, which is capable of suppressing both generation of a timing skew and the difference in latency with a simple system structure.

It is yet another object of the present invention to provide a transmitting/receiving system for transferring a signal between a plurality of functional blocks, which transmits and receives a signal in synchronization with a clock signal.

It is a further object of the present invention to provide a transmitting/receiving system for transferring a signal between a plurality of functional blocks, which reliably transmits and receives a signal in synchronization with a clock signal.

A signal transmitting/receiving system according to one aspect of the present invention includes a first device, and a plurality of second devices connected to the first device. The first device includes a transmitting circuit transmitting a control signal to the second devices, a receiving circuit receiving a response signal from the second devices, and a control circuit controlling the transmitting circuit and the receiving circuit based on a clock signal generated at a predetermined cycle. The second devices each includes a responding circuit transmitting the response signal to the receiving circuit in response to the control signal from the transmitting circuit. The signal transmitting/receiving system further includes an annular signal line connected to the transmitting circuit and the receiving circuit so as to start from the transmitting circuit and terminate at the receiving circuit, and a signal line connecting the annular signal line to the second devices. The annular signal line transfers a signal in only one direction. The annular signal line, the first device and the second devices are arranged at a surface formed in a three-dimensional space.

An annular signal line for transferring a control signal from the first device to one of the plurality of second devices and an annular signal line for transferring a response signal from one of the plurality of second devices to the first device are formed along a surface formed in a three-dimensional space (e.g., a curved surface of a sphere). The annular signal lines transfer a signal in only one direction. This enables the annular signal line for transferring a control signal (e.g., a read instruction to a memory) and the annular signal line for transferring a response signal (e.g., read data from the memory) to have exactly the same length. Since the annular signal lines for transferring a signal are formed along the surface formed in the three-dimensional space, formation of a plurality of signal lines having exactly the same length is facilitated. As a result, a system for transmitting/receiving a signal in synchronization with a clock signal while suppressing generation of a timing skew and the difference in latency can be provided as opposed to the case where a signal transmitting/receiving system is formed on a flat surface.

Preferably, the surface formed in the three-dimensional space is a curved surface of a sphere, a curved surface of a cylinder, or a surface formed from top and back surfaces of a printed circuit board.

The first device and the second devices are mounted at a curved surface of a sphere, a curved surface of a cylinder, or a surface formed from top and back surfaces of a printed circuit board. Moreover, the first device and the second devices are connected to each other through the annular signal line. This enables a signal line for transferring a read signal to a memory and a signal line for transferring read data from the memory to have exactly the same length. As a result, a signal can be transmitted between the first and second devices in synchronization with a clock signal while suppressing generation of a timing skew and the difference in latency.

Preferably, the first device further includes an output circuit outputting the clock signal to the annular signal line, an input circuit receiving the clock signal from the annular signal line, and a phase adjustment circuit adjusting a phase difference between the clock signal output from the output circuit and the clock signal applied to the input circuit.

Since the phase adjustment circuit adjust the phase difference, synchronization between the input circuit and the output circuit in the first circuit can be easily achieved.

Preferably, the phase adjustment circuit includes a circuit adjusting the phase difference so that the phase difference becomes equal to an integral multiple of the predetermined cycle or an integral multiple of half the predetermined cycle.

Since the phase adjustment circuit adjust the phase difference to an integral multiple of the predetermined cycle or the like, synchronization between the input circuit and the output circuit in the first device can be easily achieved.

A signal transmitting/receiving system according to another aspect of the present invention includes a first device, a plurality of second devices connected to the first device, and a third device for generating a clock signal at a predetermined cycle. The first device includes a transmitting circuit transmitting a control signal to the second devices, a receiving circuit receiving a response signal from the second devices, and a control circuit receiving the clock signal from the third device and controlling the transmitting circuit and the receiving circuit based on the received clock signal. The second devices each includes a responding circuit transmitting the response signal to the receiving circuit in response to the control signal from the transmitting circuit. The signal transmitting/receiving system further includes an annular signal line connected to the transmitting circuit and the receiving circuit so as to start from the transmitting circuit and terminate at the receiving circuit, and a signal line connecting the annular signal line to the second devices. The annular signal line transfers a signal in only one direction. The annular signal line, the first device, the second devices and the third device are arranged at a surface formed in a three-dimensional space.

The first device controls the transmitting circuit and the receiving circuit based on the clock signal received from the third device. This transmitting/receiving system enables an annular signal line for transmitting a control signal and an annular signal line for transmitting a response signal to have exactly the same length. Since the annular signal lines for transferring a signal are formed along the surface formed in the three-dimensional space, formation of a plurality of signal lines having exactly the same length is facilitated. As a result, a system for transmitting/receiving a signal in synchronization with a clock signal while suppressing generation of a timing skew and the difference in latency can be provided as opposed to the case where a signal transmitting/receiving system is formed on a flat surface.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 shows the structure of a semiconductor device relating to the present invention.

FIG. 2 is a signal timing chart of the semiconductor device in FIG. 1.

FIG. 3 shows the structure of another semiconductor device relating to the present invention.

FIG. 4 is a signal timing chart of the semiconductor device in FIG. 3.

FIG. 5 shows the structure of still another semiconductor device relating to the present invention.

FIGS. 6 to 9 specifically show the structures of the semiconductor device relating to the present invention.

FIG. 10 is a signal timing chart of the semiconductor device in FIG. 5.

FIG. 11 specifically shows the timing chart of FIG. 10.

FIG. 12 shows the external appearance of a spherical semiconductor device according to a first embodiment of the present invention.

FIG. 13 is a development of the semiconductor device in FIG. 12.

FIG. 14 is a signal timing chart of the semiconductor device according to the first embodiment of the present invention.

FIGS. 15 and 16 are modifications of the semiconductor device according to the first embodiment of the present invention.

FIGS. 17 to 21 show other mounting examples of the semiconductor device according to the first embodiment of the present invention.

FIGS. 22 to 24 show the structures of a control block in a semiconductor device according to a second embodiment of the present invention.

FIG. 25 is a signal timing chart of the semiconductor device according to the second embodiment of the present invention.

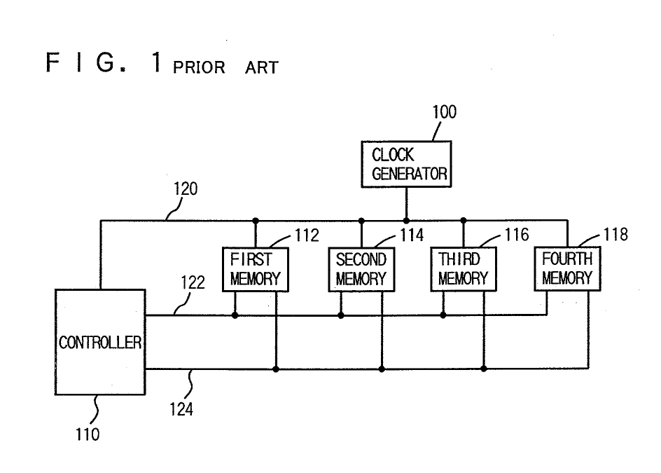

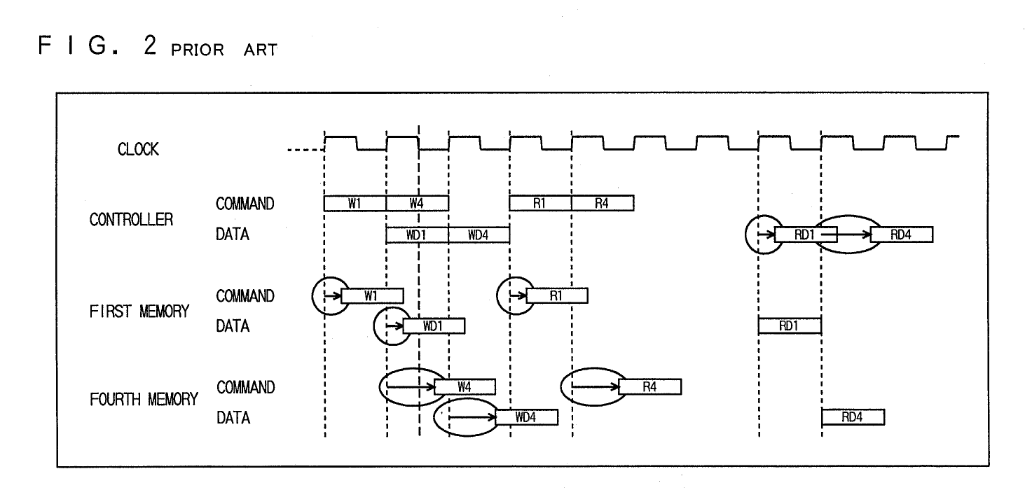

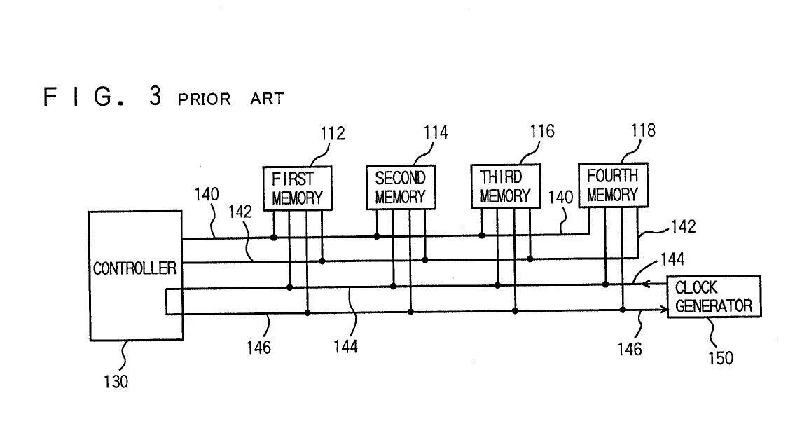

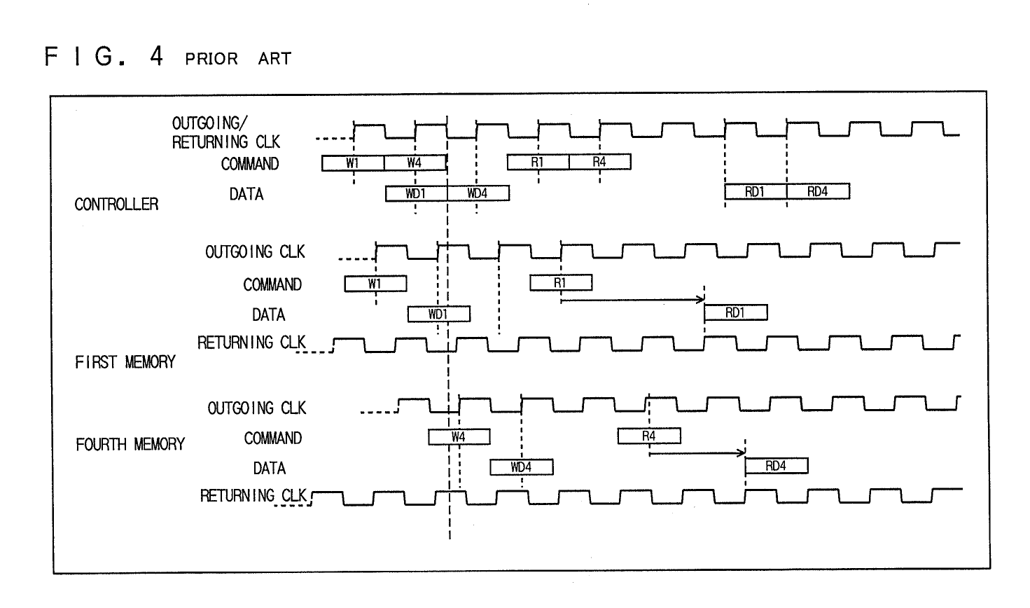

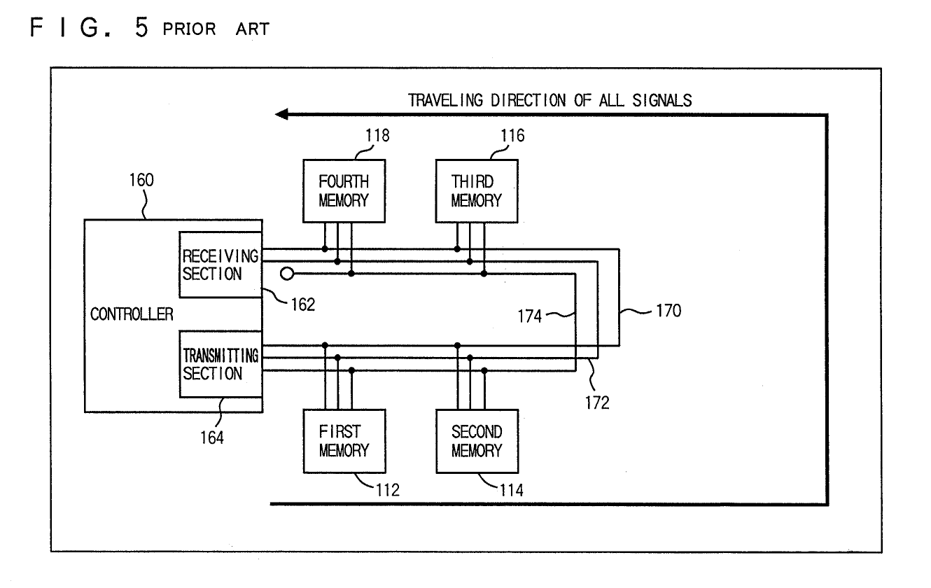

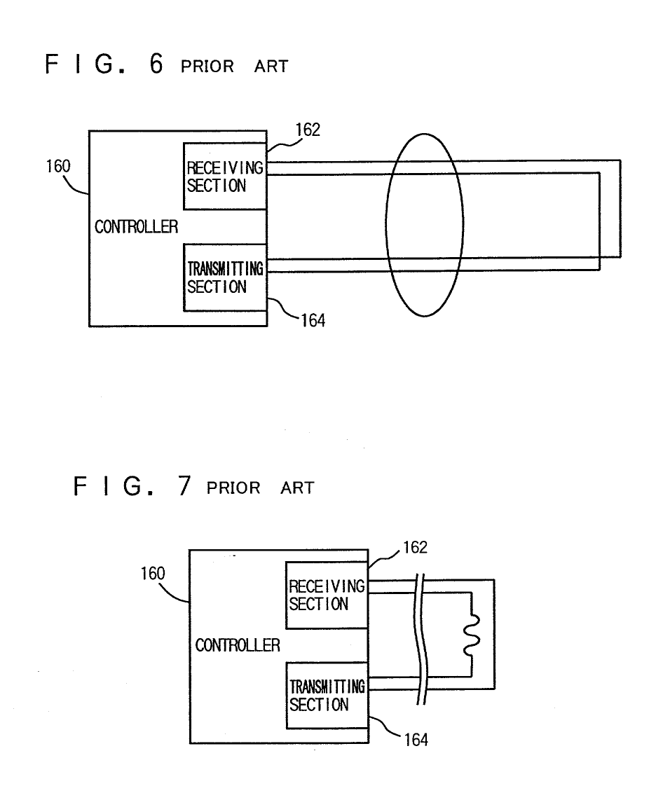

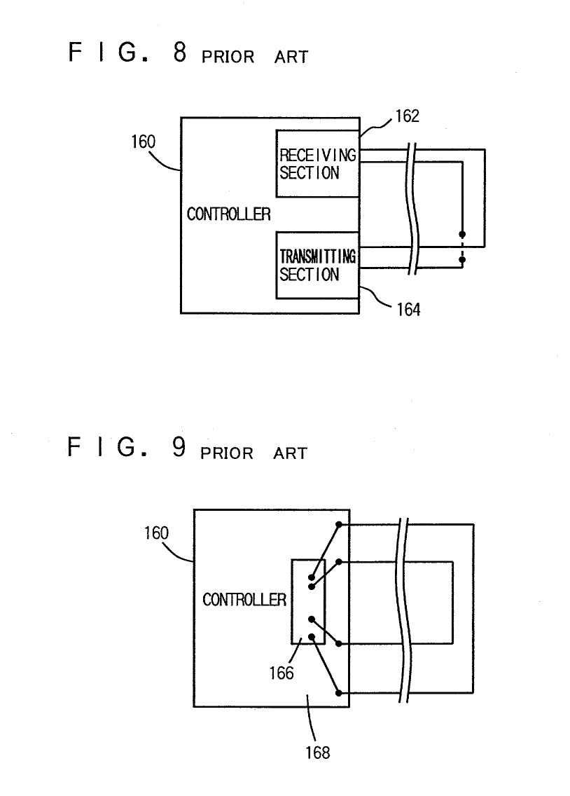

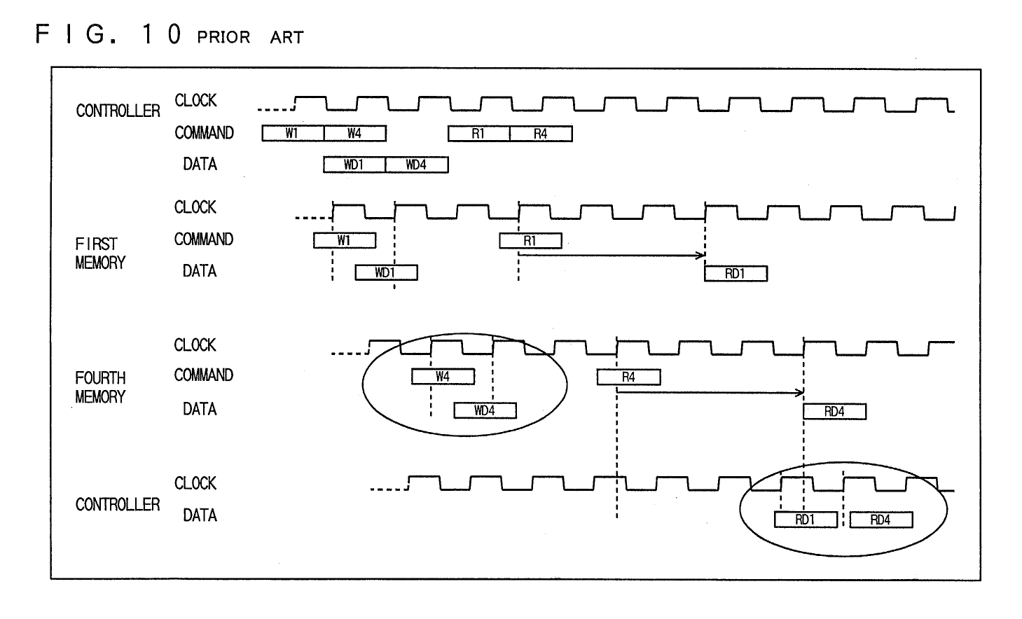

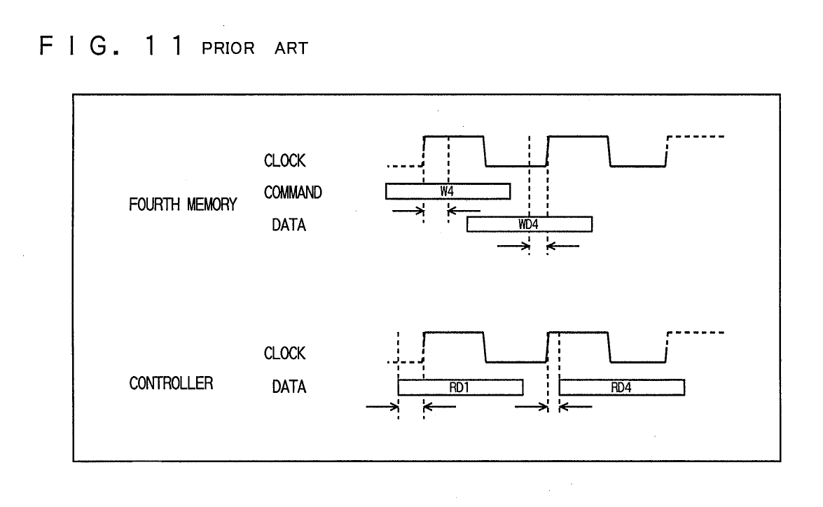

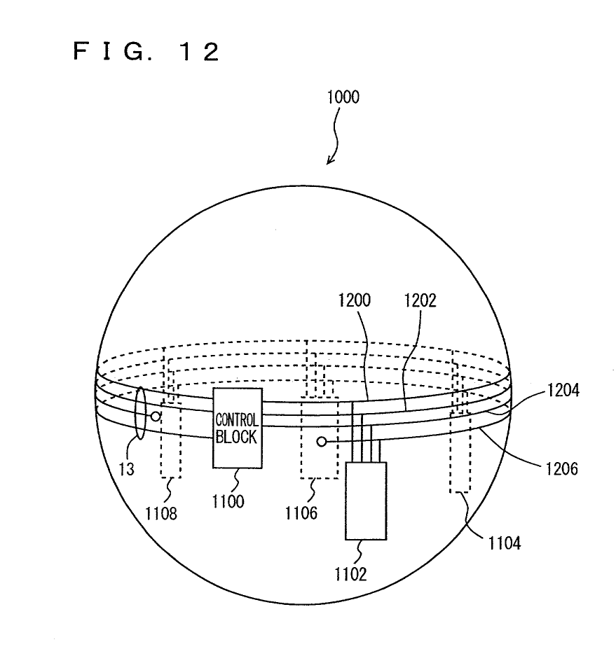

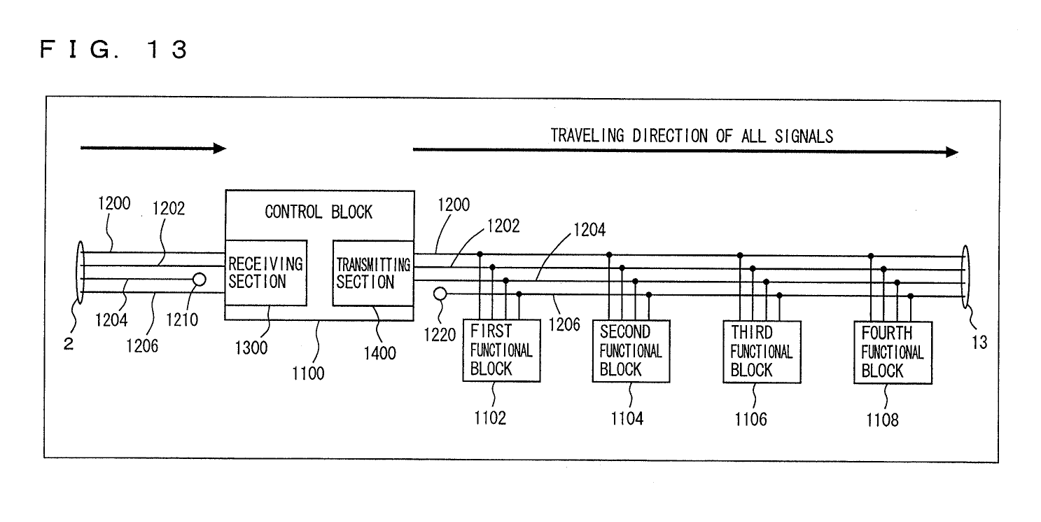

### DESCRIPTION OF THE PREFERRED EMBODIMENTS

Hereinafter, embodiments of the present invention will be described in conjunction with the accompanying drawings. The same components are denoted with the same reference numerals throughout the description and the figures. These components have the same name and functionality. Accordingly, detailed description thereof will not be repeated.

First Embodiment

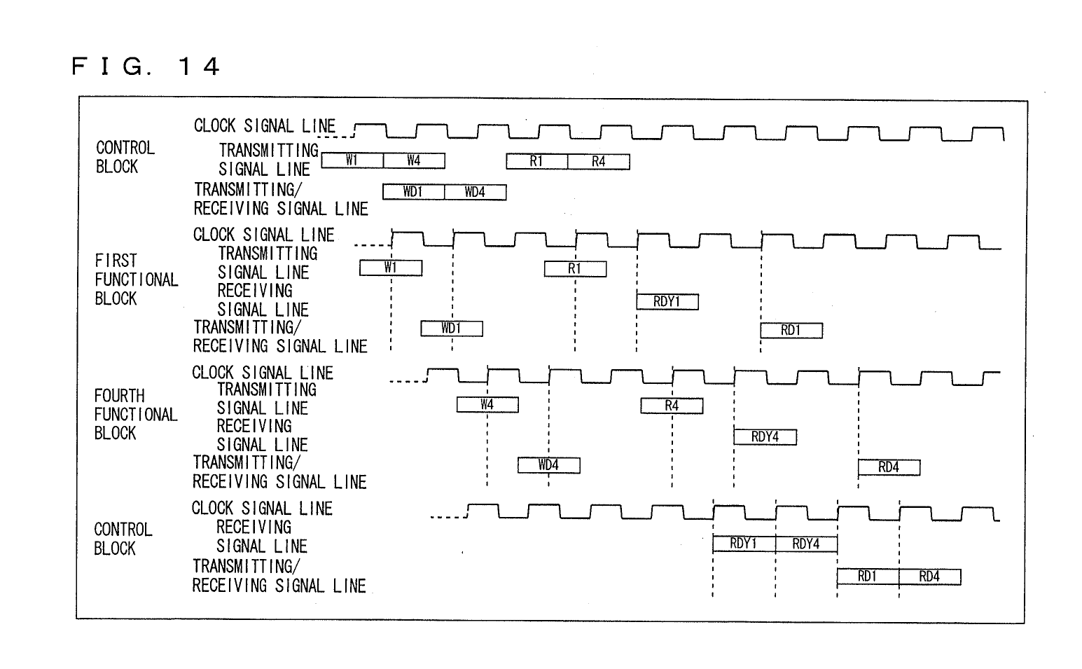

The first embodiment of the present invention will now be described with reference to FIG. 12. The semiconductor device shown in FIG. 12 is a spherical semiconductor device 1000, which includes the following blocks at the surface of the sphere: a control block 1100; a first functional block 1102; a second functional block 1104; a third functional block 1106; and a fourth functional block 1108. The first to fourth functional blocks 1102 to 1108 each transmits a response signal to the control block 1100 in response to a control signal from the control block 1100. The control block 1100 and the functional blocks 1102 to 1108 are connected to each other through the following signal lines: a clock signal line 1200 for transferring a clock signal; a transmitting/receiving signal line 1202 for transferring write data (WDn) and read data (RDn); a transmitting signal line 1204 for transferring a data write instruction (Wn) and a data read instruction (Rn); and a receiving signal line 1206 for transferring a read data ready signal (RDYn). The signal lines 1200 to 1206, which extend along the spherical surface, start from or terminate at the control block 1100.

FIG. 13 is a development of the semiconductor device 1000 in FIG. 12. In this figure, the semiconductor device 1000 is developed in a cross section 13 of FIG. 13. As shown in FIG. 13, every signal line 1200 to 1206 transfers a signal in the same direction. The transmitting signal line 1204 connected to a transmitting section 1400 is not connected to a receiving section 1300 but to a terminal section 1210. The receiving signal line 1206 connected to the receiving section 1300 is not connected to the transmitting section 1400, but to a terminal section 1220.

The control block 1100 sends a data write instruction (Wn) directed to the n^{th} functional block to the transmitting signal line 1204, and one clock later, sends write data (WDn) to the transmitting/receiving signal line 1202. The functional block stores the write data (WDn) in its internal circuit in response to the data write instruction (Wn).

The control block 1100 sends a data read instruction (Rn) directed to the n^{th} functional block to the transmitting signal line 1204. One clock after the read instruction (Rn), the functional block, if there is any data stored therein according to an earlier write instruction, sends a read data ready signal (RDYn) to the receiving signal line 1206. Two clocks after the read data ready signal (RDYn), the functional block further sends read data (RDn) to the transmitting/receiving signal line 1202.

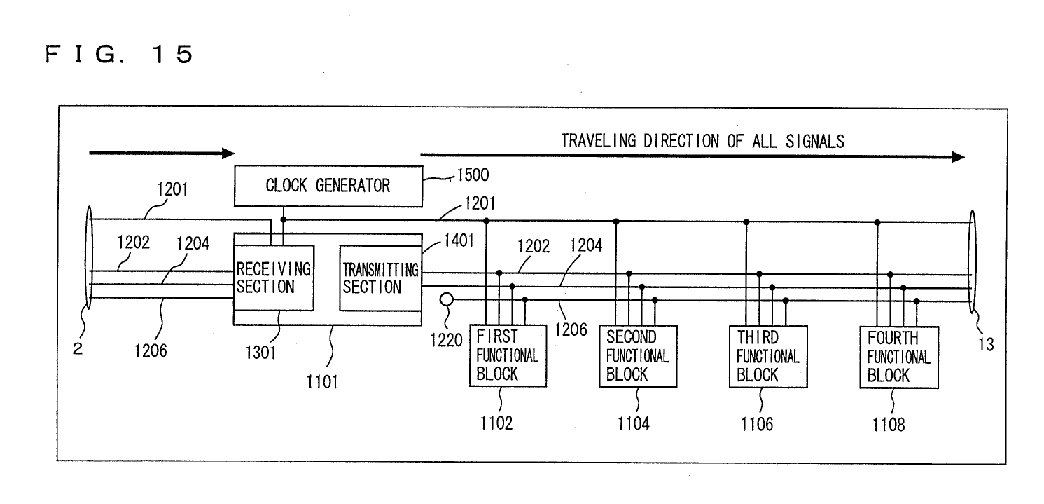

FIG. 14 is a signal timing chart of such a transmitting/receiving system. As shown in FIG. 14, the control block 1100 transfers a data write instruction (W1) to the first functional block 1102 through the transmitting signal line 1204. The first functional block 1102 receives from the control block 1100 the data write instruction (W1) in synchronization with a clock signal in the first functional block 1102, and one clock later, receives write data (WD1) therefrom. The first functional block 1102 processes the received write data (WD1) by its internal circuit.

The control block 1100 transfers a data write instruction (W4) to the fourth functional block 1108 through the transmitting signal line 1204. The fourth functional block 1104 receives from the control block 1100 the data write instruction (W4) in synchronization with a clock signal in the fourth functional block 1108, and one clock later, receives write data (WD4) therefrom. The fourth functional block 1108 processes the received write data (WD4) by its internal circuit.

The control block 1100 transfers a data read instruction (R1) to the first functional block 1102 through the transmitting signal line 1204. The first functional block 1102 receives the data read instruction (R1) in synchronization with a clock signal in the first functional block 1102. If the first functional block 1102 stores the data corresponding to that read instruction, it transmits a read data ready signal (RDY1) to the control block 1200 one clock after the data read instruction (R1). The first functional block 1102 also transmits read data (RD1) to the transmitting/receiving signal line 1202 two clocks after the read data ready signal (RDY1). The control block 1100 receives the read data (RD1) two clocks after the read data ready signal (RDY1), and processes the received read data (RD1) by its internal circuit.

The control block 1100 transfers a data read instruction (R4) to the fourth functional block 1108 through the transmitting signal line 1204. The fourth functional block 1108 receives the data read instruction (R4) in synchronization with a clock signal in the fourth functional block 1108. If the fourth functional block 1108 stores the data corresponding to that read instruction, it transmits a read data ready signal (RDY4) to the control block 1100 one clock after the data read instruction (R4). The fourth functional block 1108 also transmits read data (RD4) to the transmitting/receiving signal line 1202 two clocks after the read data ready signal (RDY4). The control block 1100 receives the read data (RD4) two clocks after the read data ready signal (RDY4), and processes the received read data (RD4) by its internal circuit.

As can be seen from the timing chart of FIG. 14, generation of a timing skew and the difference in latency which are caused by the difference in distance between the control block and the first and fourth functional blocks 1102, 1108 are suppressed, and the instruction signal and the data signal is synchronized with the clock signal.

As has been described above, according to the semiconductor device of the present embodiment, a control block and a plurality of functional blocks are connected to each other through a plurality of annular signal lines. The control block, the plurality of functional blocks and the plurality of annular signal lines are formed on a surface formed in the three-dimensional space. This enables the plurality of signal lines to be formed with exactly the same length. As a result, generation of a timing skew and the difference in latency are suppressed, enabling synchronization between the clock signal and the transmitted signal (instruction).

First Modification of First Embodiment

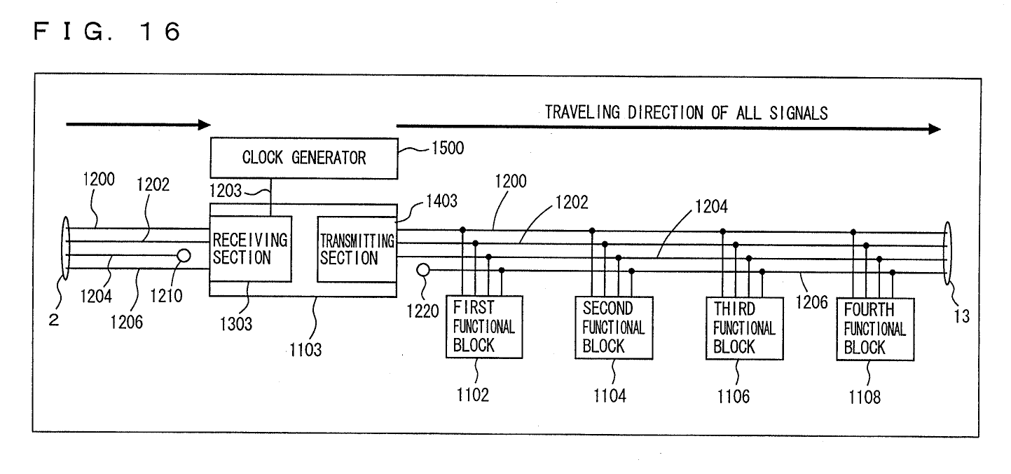

The first modification of the first embodiment will now be described with reference to FIG. 15. In this modification, the same components as those of the first embodiment are denoted with the same reference numerals. These components have the same functionality as that of the first embodiment. Accordingly, detailed description thereof will not be repeated.

In the first modification of FIG. 15, the control block 1101 does not include an internal clock generator, but includes an external clock generator 1500. The control block 1101 includes a receiving section 1301 and a transmitting section 1401. The first functional block 1102, the second functional block 1104, the third functional block 1106 and the fourth functional block 1108 receive a clock signal from the clock generator 1500 through a clock signal line 1201. The receiving section 1301 receives not only the clock signal directly from the clock generator 1500 but also the clock signal having traveled through the annular clock signal line 1201.

According to this modification, generation of a timing skew and the difference in latency are suppressed as in the first embodiment even if the control block 1101 does not include any internal clock generator, thereby achieving synchronization between the clock signal and the transmitted signal (instruction) as well as synchronization between the clock signal and the transmitted/received signal (data).

Second Modification of First Embodiment

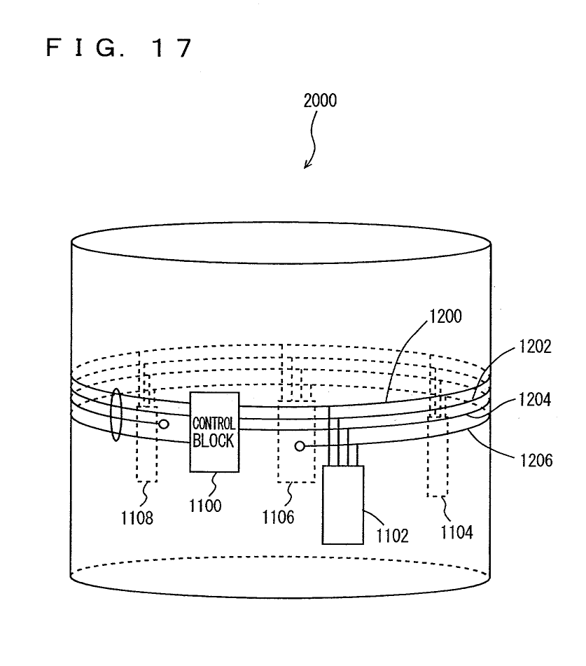

The second modification of the first embodiment will now be described with reference to FIG. 16. In this modification, the same components as those in the first embodiment and the first modification thereof are denoted with the same reference numerals. These components have the same functionality as that of the first embodiment and the first modification thereof. Therefore, detailed description thereof will not be repeated.

In the second modification of FIG. 16, the control block 1103 does not include an internal clock generator, but includes an external clock generator 1500. The control block 1103 includes a receiving section 1303 and a transmitting section 1403. The receiving section 1303 receives a clock signal from the clock generator 1500 through a clock signal line 1203. The receiving section 1303 applies the received clock signal to the first functional block 1102, the second functional block 1104, the third functional block 1106 and the fourth functional block 1108 through the clock signal line 1200. The receiving section 1303 receives not only the clock signal directly from the clock generator 1500 but also the clock signal having traveled through the annular clock signal line 1200.

According to this modification, generation of a timing skew and the difference in latency are suppressed as in the first embodiment even if the control block 1101 does not include any internal clock generator, thereby achieving synchronization between the clock signal and the transmitted signal (instruction) as well as synchronization between the clock signal and the transmitted/received signal (data).

Other Mounting Examples of First Embodiment

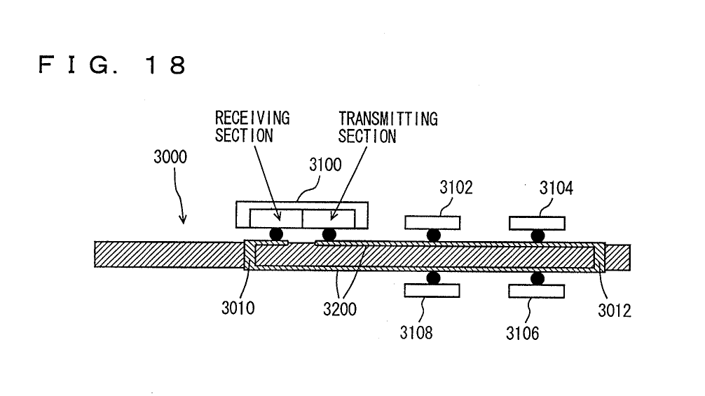

Other mounting examples of the control block, functional blocks and annular signal lines in the semiconductor device will now be described with reference to FIGS. 17 to 21. In these mounting examples, the same components as those of the first embodiment are denoted with the same reference numerals. These components have the same functionality as that of the first embodiment. Accordingly, detailed description thereof will not be repeated.

FIG. 17 shows the external appearance of a cylindrical semiconductor device 2000 according to another mounting example. The cylindrical semiconductor device 2000 of FIG. 17 includes the following blocks at the curved surface of the cylinder: a control block 1100; a first functional block 1102; a second functional block 1104; a third functional block 1106; and a fourth functional block 1108. The first to fourth functional blocks 1102 to 108 each transmits a response signal to the control block 1100 in response to a control signal therefrom. The control block 1100 and the functional blocks 1102 to 1108 are connected to each other through a clock signal line 1200, a transmitting/receiving signal line 1202, a transmitting signal line 1204 and a receiving signal line 1206. These signal lines 1200 to 1206, which extend along the curved surface of the cylinder, start from or terminate at the control block 1100.

The development of the cylindrical semiconductor device 2000 of FIG. 17 is the same as FIG. 13. Accordingly, the same operation as that of the first embodiment can be realized.

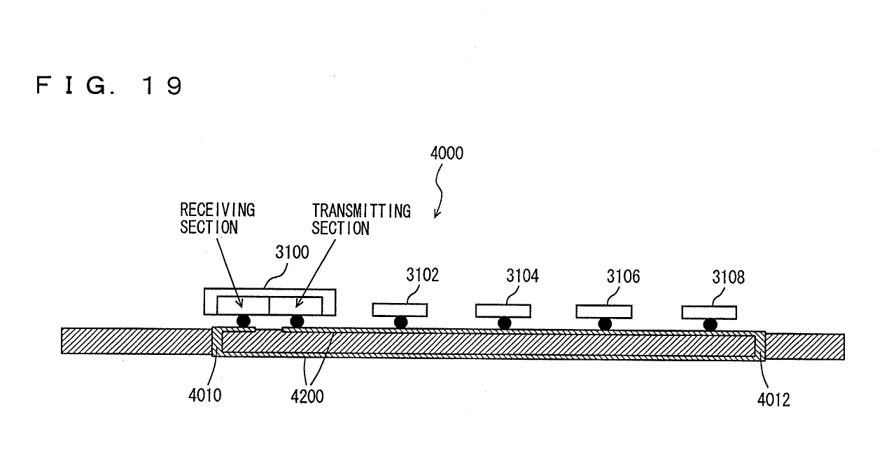

FIG. 18 is a side view of a semiconductor device 3000 mounted on a printed circuit board according to still another example of the first embodiment. The semiconductor device 3000 of FIG. 18 includes a control LSI (Large Scale Integrated circuit) 3100 including a receiving section and a transmitting section, a first controlled LSI 3102, a second controlled LSI 3104, a third controlled LSI 3106 and a fourth controlled LSI 3108. The control LSI 3100 and the controlled LSIs 3102 to 3108 are connected to each other through annular signal lines formed in a wiring layer 3200. The annular signal lines are the clock signal line, transmitting/receiving signal line, transmitting signal line and receiving signal line of the first embodiment. The printed circuit board has via holes 3010, 3012 through which the signal lines extend. The annular signal lines are thus formed along the curved surface in the three-dimensional space formed from the top and back surfaces of the printed circuit board.

The development of the semiconductor device 3000 mounted on the printed circuit board shown in FIG. 18 is the same as FIG. 13. Accordingly, the same operation as that of the first embodiment can be realized.

Other Mounting examples

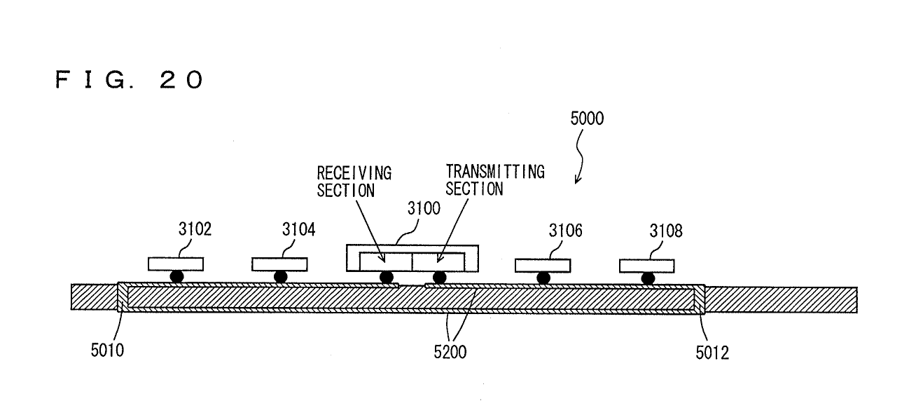

FIGS. 19 and 20 are side views of semiconductor devices 4000, 5000 mounted on a printed circuit board according to other mounting examples, respectively. The semiconductor devices 4000 and 5000 of FIGS. 19 and 20 are different from the semiconductor device 3000 in that the first controlled LSI 3102, the second controlled LSI 3104, the third controlled LSI 3106 and the fourth controlled LSI 3108 are arranged on the top surface of the printed circuit board. The semiconductor devices 4000 and 5000 of FIGS. 19 and 20 are different from each other in arrangement of the control LSI and the controlled LSIs. As shown in FIG. 19, signal lines extending through via holes 4010, 4012 are formed in a wiring layer 4200 as annular signal lines in the three-dimensional space. As shown in FIG. 20, signal lines extending through via holes 5010, 5012 are formed in a wiring layer 5200 as annular signal lines in the three-dimensional space.

The respective developments of the semiconductor devices 4000, 5000 mounted on the printed circuit board shown in FIGS. 19 and 20 are the same as FIG. 13. Accordingly, the same operation as that of the first embodiment can be realized.

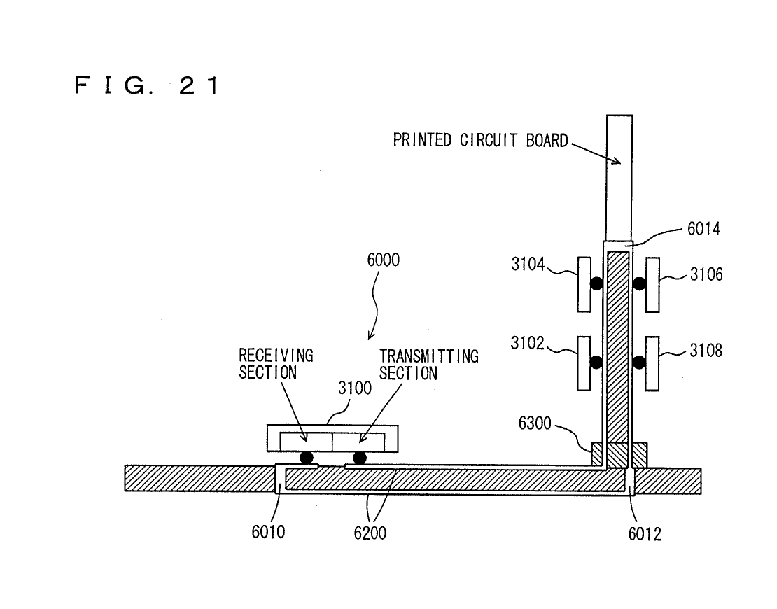

FIG. 21 is a side view of a semiconductor device 6000 mounted on a printed circuit board according to a further mounting example. In the semiconductor device 6000 of FIG. 21, the control LSI 3100, the first controlled LSI 3102, the second controlled LSI 3104, the third controlled LSI 3106 and the fourth controlled LSI 3108 are mounted on a plurality of printed circuit boards. Signal lines extending through via holes 6010, 6012, 6014 are formed in a wiring layer 6200 as annular signal lines in the three-dimensional space. The plurality of printed circuit boards are coupled to each other by a socket 6300.

The development of the semiconductor device 6000 mounted on the printed circuit boards shown in FIG. 21 is the same as FIG. 13. Accordingly, the same operation as that of the first embodiment can be realized.

Second Embodiment

A semiconductor device of the second embodiment is different from that of the first embodiment in that the semiconductor device of the second embodiment has an additional function to adjust the phase of the clock signal. The same components as those of the first embodiment are denoted with the same reference numerals. These components have the same functionality as that of the first embodiment. Accordingly, detailed description thereof will not be repeated.

The control block outputs a clock signal (first clock signal) as well as receives a clock signal having traveled through an annular clock signal line (second clock signal). The first clock signal and the second clock signal are not necessarily in phase with each other. The control block in the semiconductor device of the present embodiment senses the phase difference between the first and second clock signals and adjusts them so that they become in phase with each other.

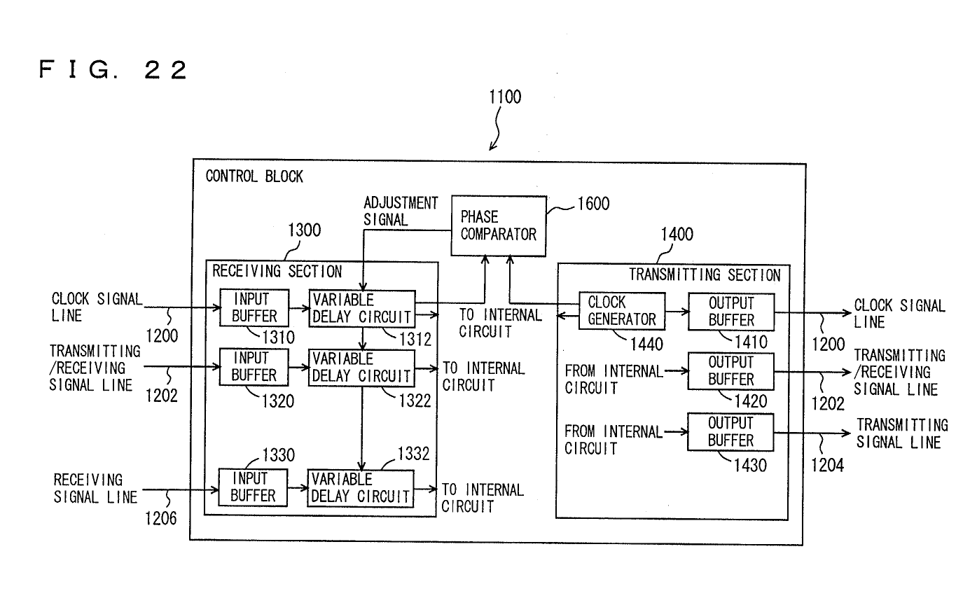

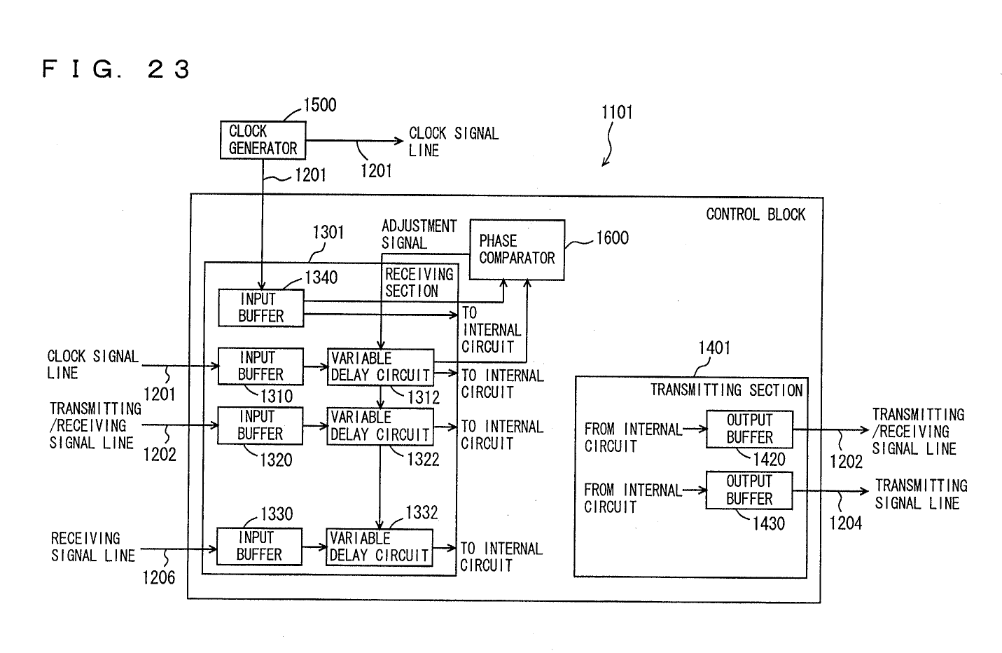

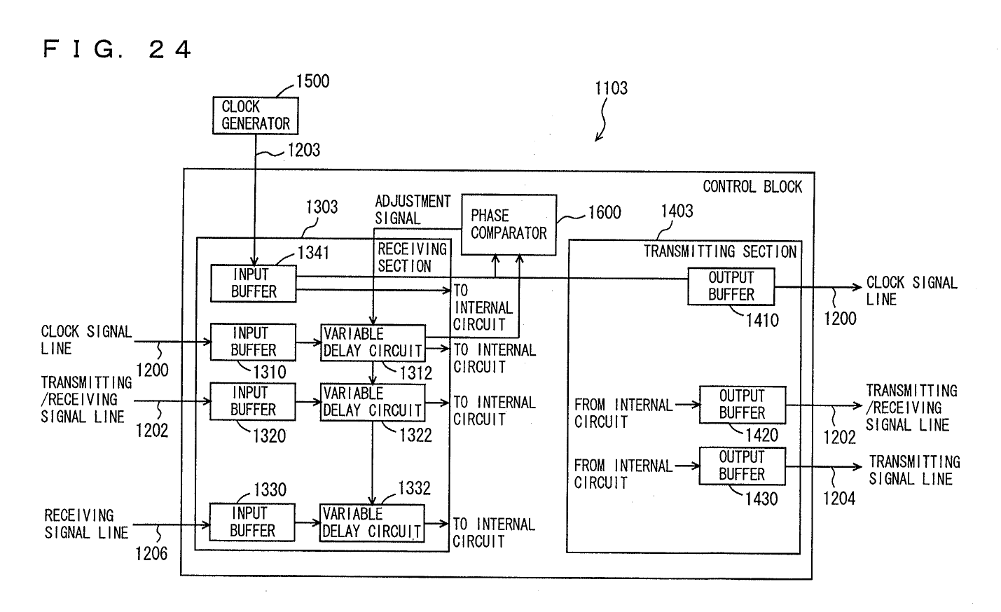

FIG. 22 shows the structure of the control block 1100 in FIG. 13. FIG. 23 shows the structure of the control block 1101 in FIG. 15. FIG. 24 shows the structure of the control block 1103 in FIG. 16.

Referring to FIG. 22, the control block 1100 includes a receiving section 1300, a transmitting section 1400 and a phase comparator 1600.

The receiving section 1300 includes an input buffer 1310 connected to the clock signal line 1200, a variable delay circuit 1312 connected to the input buffer 1310, an input buffer 1320 connected to the transmitting/receiving signal line 1202, a variable delay circuit 1322 connected to the input buffer 1320, an input buffer 1330 connected to the receiving signal line 1206, and a variable delay circuit 1332 connected to the input buffer 1330.

The variable delay circuit 1322 is connected to the variable delay circuit 1332. The variable delay circuit 1312 is connected to the variable delay circuit 1322 and the phase comparator 1600.

The transmitting section 1400 includes an output buffer 1410 connected to the clock signal line 1200, a clock generator 1440 connected to the output buffer 1410, an output buffer 1420 connected to the transmitting/receiving signal line 1202, and an output buffer 1430 connected to the transmitting signal line 1204. The clock generator 1440 is connected to the phase comparator 1600.

The phase comparator 1600 compares the phase of a first clock signal received from the clock generator 1440 with that of a second clock signal received through the input buffer 1310 to calculate the phase difference therebetween. The phase comparator 1600 then produces an adjustment signal for delaying the second clock signal so that the phase difference becomes equal to an integral multiple of the cycle of the clock signal or an integral multiple of a half cycle thereof. The adjustment signal thus produced is transmitted to the variable delay circuit 1312. The variable delay circuits 1312, 1322, 1332 retard the phase of an input signal based on the adjustment signal.

Referring to FIG. 23, the control block 1101 is different from the control block 1100 in that the control block 1101 has an external clock generator 1500 and the clock generator 1500 transmits a dock signal directly to the functional blocks. Since the control block 1101 is otherwise the same as the control block 1100, detailed description thereof will not be repeated.

Referring to FIG. 24, the control block 1103 is different from the control block 1101 in that the clock generator 1500 transmits a clock signal to the functional blocks through the transmitting section 1403. Since the control block 1103 is otherwise the same as the control block 1101, detailed description thereof will not be repeated.

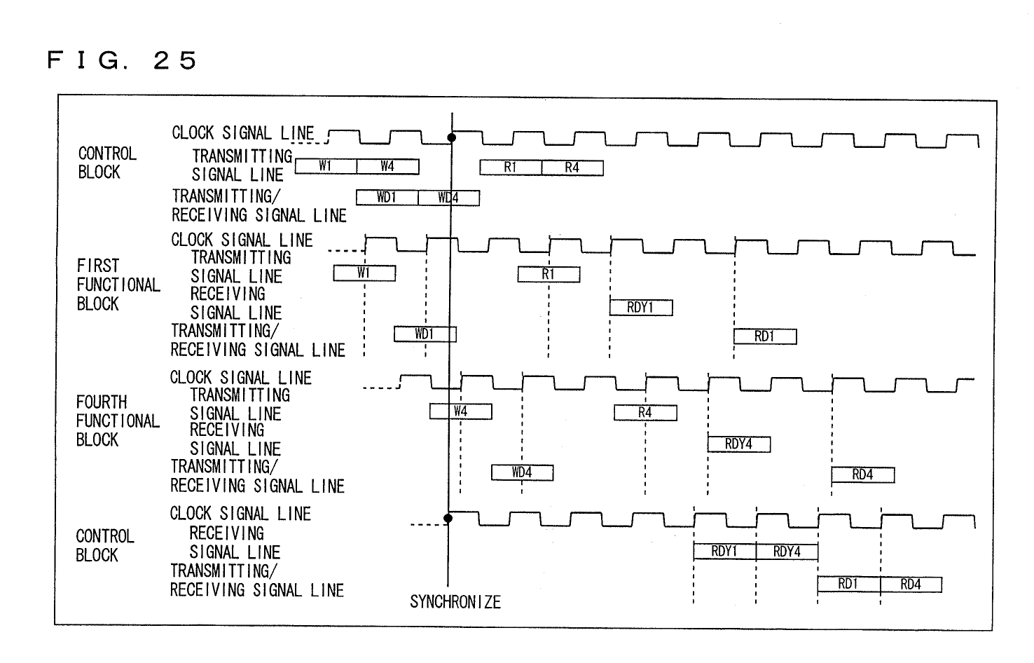

The control blocks 1100, 1101, 1103 having such a structure adjust the phase of the clock signal applied to the control blocks 1100, 1101, 1103 again after traveling through the annular clock signal line. More specifically, the control blocks 1100, 1101, 1103 retard the phase so that the phase difference becomes equal to an integral multiple of the cycle of the clock signal or an integral multiple of the half cycle thereof. FIG. 25 is a signal timing chart illustrating this operation. As shown in FIG. 25, the clocks traveling through the annular signal line are synchronized with each other. As a result, respective operations of the input circuitry and the output circuitry can be conducted with a single-phase clock signal.

The semiconductor device of the present invention enables the input circuitry and output circuitry of the control block to be operated with an in-phase clock signal, allowing for simplified operation of the semiconductor device.

Although the present invention has been described and illustrated in detail, it is clearly understood that the same is by way of illustration and example only and is not to be taken by way of limitation, the sprit and scope of the present invention being limited only by the terms of the appended claims.

What is claimed is:

1. A signal transmitting/receiving system, comprising:
a first device; and
a plurality of second devices connected to said first device, wherein
said first device includes a transmitting means for transmitting a control signal to said second devices, a receiving means for receiving a response signal from said second devices, and a control means for controlling said transmitting means and said receiving means based on a clock signal generated at a predetermined cycle, and
said second devices each includes a responding means for transmitting the response signal to said receiving means in response to the control signal from said transmitting means, said signal transmitting/receiving system further comprising:
an annular signal line connected to said transmitting means and said receiving means, said annular signal line starting from said transmitting means and terminating at said receiving means; and
a signal line connecting said annular signal line to said second devices, wherein
said annular signal line transfers a signal in only one direction, and
said annular signal line, said first device and said second devices are arranged at a surface formed in a three-dimensional space.

2. The signal transmitting/receiving system according to claim 1, wherein said first device is a memory controller, and said second device is a memory device.

3. The signal transmitting/receiving system according to claim 1, wherein said surface formed in said three-dimensional space is a curved surface of a sphere.

4. The signal transmitting/receiving system according to claim 1, wherein said surface formed in said three-dimensional space is a curved surface of a cylinder.

5. The signal transmitting/receiving system according to claim 1, wherein said surface formed in said three-dimensional space is a surface formed from top and back surfaces of a printed circuit board.

6. The signal transmitting/receiving system according to claim 1, wherein said first device further includes an output means for outputting said clock signal to said annular signal line, an input means for receiving said clock signal from said annular signal line, and a phase adjustment means for adjusting a phase difference between the clock signal output from said output means and the clock signal applied to said input means.

7. The signal transmitting/receiving system according to claim 6, wherein said phase adjustment means includes a means for adjusting said phase difference so that the phase difference becomes equal to an integral multiple of said predetermined cycle or an integral multiple of half said predetermined cycle.

8. A signal transmitting/receiving system, comprising:
a first device;
a plurality of second devices connected to said first device; and
a third device for generating a clock signal at a predetermined cycle, wherein
said first device includes a transmitting means for transmitting a control signal to said second devices, a receiving means for receiving a response signal from said second devices, and a control means for receiving said clock signal from said third device and controlling said transmitting means and said receiving means based on the received clock signal, and
said second devices each includes a responding means for transmitting the response signal to said receiving means in response to the control signal from said transmitting means, said signal transmitting/receiving system further comprising:
an annular signal line connected to said transmitting means and said receiving means, said annular signal line starting from said transmitting means and terminating at said receiving means; and
a signal line connecting said annular signal line to said second devices, wherein
said annular signal line transfers a signal in only one direction, and
said annular signal line, said first device, said second devices and said third device are arranged at a surface formed in a three-dimensional space.

9. The signal transmitting/receiving system according to claim 8, wherein said first device is a memory controller, and said second device is a memory device.

10. The signal transmitting/receiving system according to claim 8, wherein said surface formed in said three-dimensional space is a curved surface of a sphere.

11. The signal transmitting/receiving system according to claim 8, wherein said surface formed in said three-dimensional space is a curved surface of a cylinder.

12. The signal transmitting/receiving system according to claim 8, wherein said surface formed in said three-dimensional space is a surface formed from top and back surfaces of a printed circuit board.

13. The signal transmitting/receiving system according to claim 8, wherein said third device includes an output means for outputting said clock signal to said annular signal line, and said first device further includes an input means for receiving said clock signal from said annular signal line, and a phase adjustment means for adjusting a phase difference between the clock signal output from said output means and the clock signal applied to said input means.

14. The signal transmitting/receiving system according to claim 13, wherein said phase adjustment means includes a means for adjusting said phase difference so that the phase difference becomes equal to an integral multiple of said predetermined cycle or an integral multiple of half said predetermined cycle.
